(19) United States
(12) Patent Application Publication
(10) Pub. No.: US 2003/0125869 A1
(43) Pub. Date: Jul. 3, 2003

(54) Method and apparatus for creating a geographically limited vocabulary for a speech recognition system

(75) Inventor: Hugh William Adams JR., Wappinger Falls, NY (US)

Correspondence Address: Ryan, Mason & Lewis, LLP, Suite 205, 1300 Post Road, Fairfield, CT, 06430, US

(73) Assignee: International Business Machines Corporation, Armonk, NY

(21) Appl. No.: 10/040,346

(22) Filed: Jan. 2, 2002

(51) Int. Cl. G01C 21/00

(52) U.S. Cl. 701/200; 704/200

(57) ABSTRACT

A speech recognition input interface for a portable computing device is disclosed that limits the geographic references in a speech recognition vocabulary, such as street names, local landmarks and points of interest, to those geographic references that are within a predefined distance of the current location of a user. The predefined distance may be varied, for example, in accordance with the expected range of a user. Thus, the present invention provides a vocabulary containing only those entries that are most likely to be utilized by the speech recognition system, based on the current location and expected range of the user. A navigation system uses an improved speech recognition interface in conjunction with a position location device that determines a current location of a user within a geographic domain. A limiting process generates a navigational vocabulary containing geographic references that are most likely to be utilized, in order to improve the accuracy of the speech recognition interface.

### FIELD OF THE INVENTION

The present invention relates generally to speech recognition techniques and, more particularly, to methods and apparatus that constrain a vocabulary for such speech recognition systems based on the position of the user.

### BACKGROUND OF THE INVENTION

Portable electronic devices, such as portable computers and personal digital assistants (PDAs), are increasingly popular in today's consumer marketplace. As such portable electronic devices become ever more compact and powerful, they are able to support applications having higher requirements for storage or computing power (or both). For example, many automobiles now include navigational aids that can provide directions or identify local areas of interest, based on the current location of the user. The current location of the user may be automatically obtained, for example, using a global positioning system (GPS) or Radio Frequency Identification (RFID) tags.

Such portable devices offer increased flexibility and convenience, and may be used from virtually any location, or even while traveling. A user, however, may easily become distracted when using a portable device, especially when the device requires a manual input. This is particularly hazardous if the portable device is being used by the driver of an automobile.

A number of techniques have been proposed or developed for automating the input to electronic devices or for otherwise allowing “hands-free” operation. In fact, a number of jurisdictions require drivers that use a cellular telephone to employ a hands-free cellular device, to reduce the number of motor vehicle accidents caused by a driver that is distracted while placing or receiving a telephone call. Currently, user input interfaces for portable devices include miniature keyboards, keypads, touch screens, handwriting recognition systems, and speech recognition.

Speech recognition provides a particularly natural and convenient input interface for portable devices. Generally, a speech recognition interface for a portable computing device converts a user's speech to a text format for processing. Speech recognition can be divided into two basic types, namely, dictation and command and control. Dictation techniques employ a full vocabulary of approximately 100,000 words and allow users to dictate documents. Command and control techniques employ a finite set of possible actions and objects to control specific tasks. Command and control techniques require users to use the explicit words in the vocabulary. For example, if the word “yes” is in the vocabulary, but the word “ok” is not in the vocabulary, the user must say the word “yes” to be recognized (and the word “ok” will be ignored). As command and control tasks and objects are expanded, the recognition accuracy degrades.

Most commercially available speech recognition products, such as the ViaVoice™ speech recognition system, commercially available from IBM Corporation of Armonk, N.Y., offer both dictation and command and control capabilities. Other hardware manufactures have created small command and control speech recognition systems for specific limited applications, such as the control of the accessories in an automobile. While dictation techniques generally offer considerable flexibility at the expense of transcription accuracy, command and control techniques tend to offer greater accuracy with significantly constrained flexibility. A need therefore exists for a speech recognition system that offers the benefits of both dictation and command and control techniques. A further need exists for a speech recognition system that employs a vocabulary containing a rich set entries that are most likely to be utilized. Yet another need exists for an improved speech recognition interface for a personal computing device.

### SUMMARY OF THE INVENTION

A speech recognition input interface for a portable computing device is disclosed that limits the geographic references in a speech recognition vocabulary, such as street names, local landmarks and points of interest, to those geographic references that are within a predefined distance of the current location of a user. The predefined distance may be varied, for example, in accordance with the expected range of a user. Thus, the present invention provides a vocabulary containing only those entries that are most likely to be utilized by the speech recognition system, based on the current location and expected range of the user.

In an exemplary navigation system embodiment, an improved speech recognition interface is used in conjunction with a position location device that determines a current location of a user within a geographic domain. A limiting process generates a navigational vocabulary containing geographic references that are most likely to be utilized, in order to improve the accuracy of the speech recognition interface.

A more complete understanding of the present invention, as well as further features and advantages of the present invention, will be obtained by reference to the following detailed description and drawings.

### BRIEF DESCRIPTION OF THE DRAWINGS

FIG. 1 is a graphic representation of a geographic area and a limiting box around a user in accordance with the present invention;

FIG. 2 is a block diagram of a navigation system according to the present invention;

FIG. 3 is a sample table of an updated speech vocabulary in accordance with the present invention; and

FIG. 4 is flow chart of an exemplary limiting process incorporating features of the present invention.

### DESCRIPTION OF PREFERRED EMBODIMENTS

The present invention recognizes that the accuracy of a speech recognition system increases as the number of similar sounding possible alternatives becomes smaller. The geographic database for a metropolitan area, for example, will consist of thousands of street names. Under a brute force approach, all these street names in the metropolitan area would be entered into the speech recognition vocabulary. If the user is in an automobile, this might be appropriate since the range of travel of the vehicle could possibly be anywhere in the city. However, if the user is walking, the possible number of destinations that the person may wish to request can be limited to a finite geographic area.

According to one feature of the present invention, the geographic references, such as street names and landmarks, in a speech recognition vocabulary are limited to those geographic references that are within a predefined distance of the current location of a user. The predefined distance may be varied, for example, in accordance with the expected range of a user. For example, the predefined distance for a user traveling by automobile may be larger than the predefined distance for a user traveling on foot. Thus, a navigational vocabulary is generated in accordance with the present invention containing only those entries that are most likely to be utilized, based on the current location and expected range of the user.

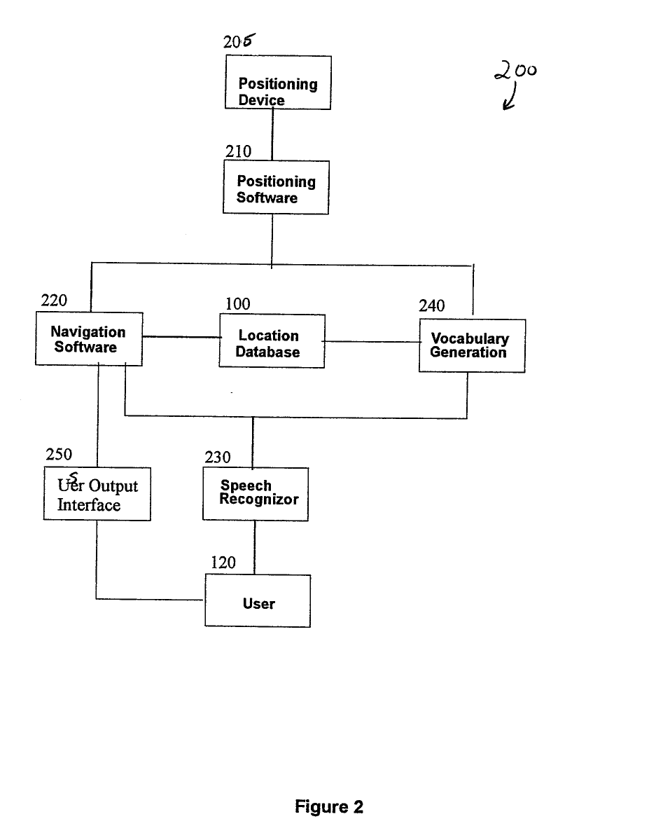

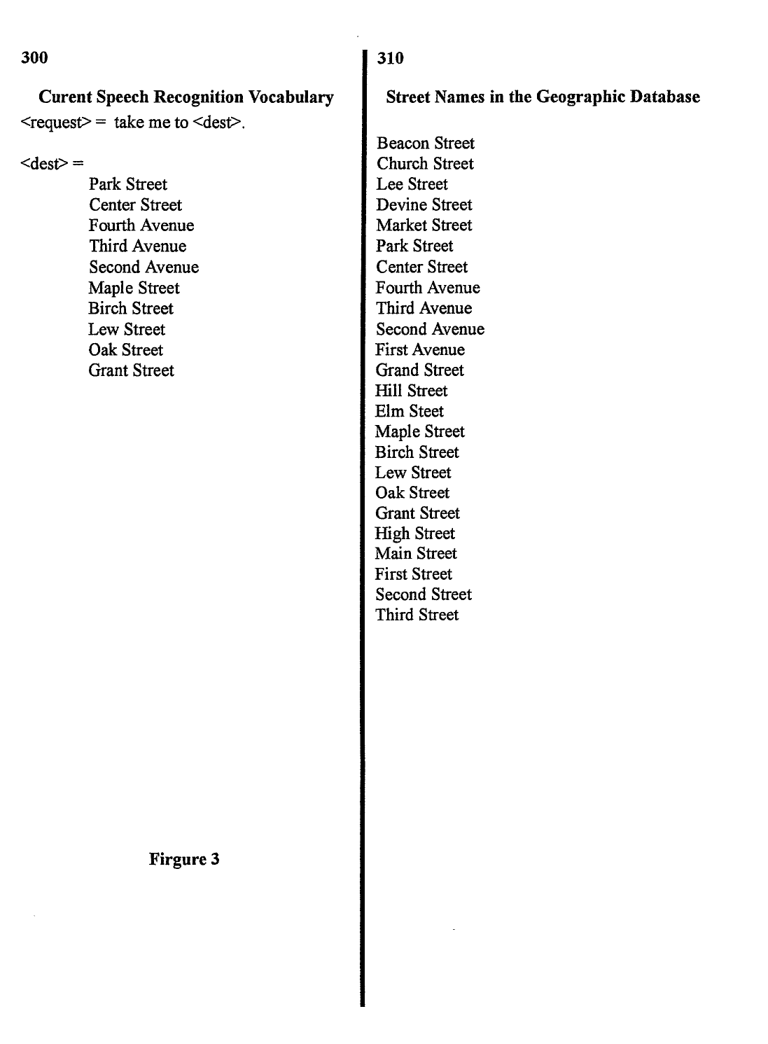

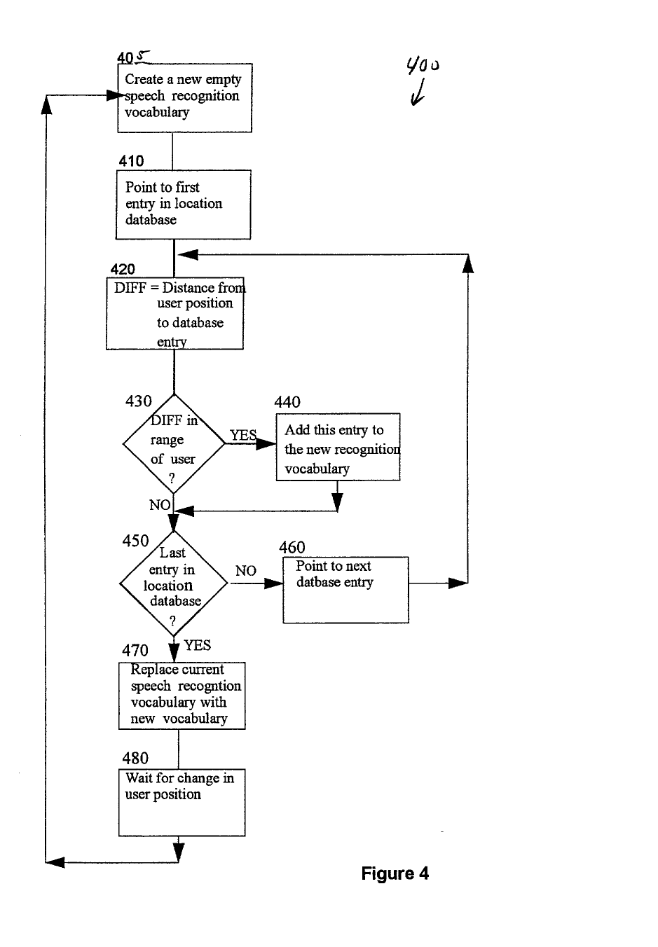

Thus, in an exemplary implementation, the present invention provides a navigation system 200, discussed further below in conjunction with FIG. 2, that uses an improved speech recognition interface. The navigation system 200 has a position location device for determining a current location of a user within a geographic domain. One or more geographic data bases 300, discussed further below in conjunction with FIG. 3, are stored in one or more memories of the navigation system 200. The geographic database 300 has information about the geographic domain. A limiting process 400, discussed further below in conjunction with FIG. 4, periodically collects culled information from the geographic database 300 for a subarea within the geographic domain, e.g., an area within a predefined distance from the current location of the. A speech recognition system 230 (FIG. 2) has a vocabulary that is updated by the limiting process 400 to include the culled information and to delete prior culled information. In this manner, the speech vocabulary contains entries that are most likely to be utilized, in order to improve the accuracy of the speech recognition interface.

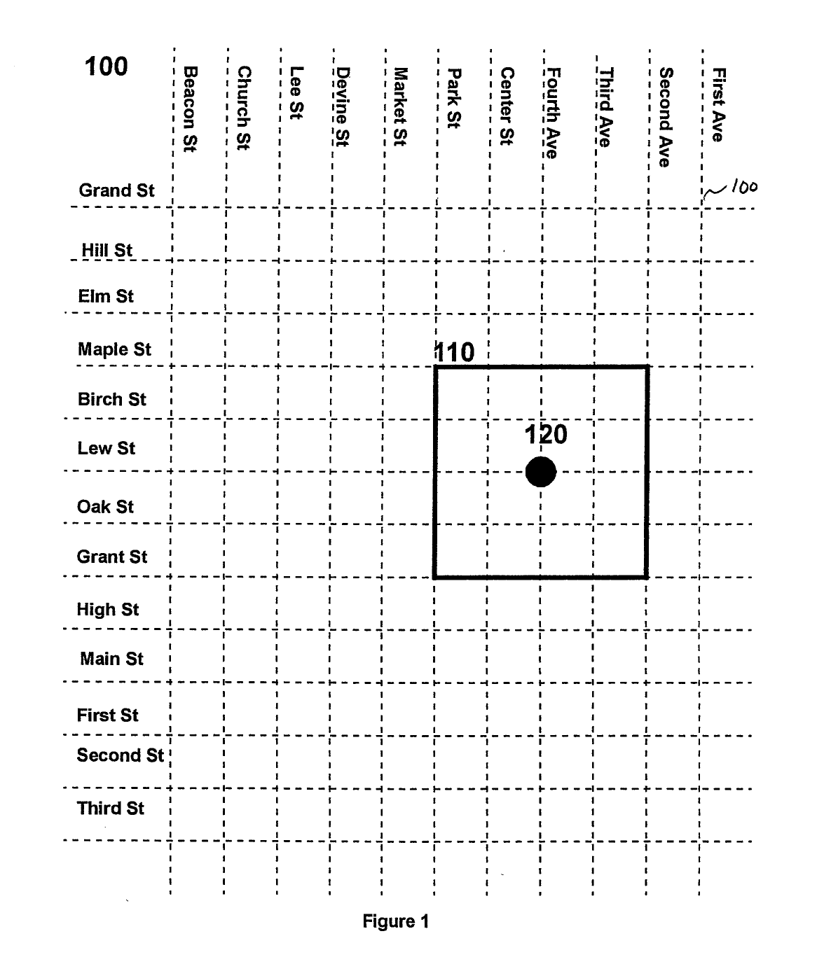

FIG. 1 illustrates a geographic area 100 and an exemplary limiting box 110 surrounding a user 120 in accordance with the present invention. According to one aspect of the present invention, only the names of streets intersecting with the limiting area 110 and landmarks within the limiting area 110 will be in a speech recognition vocabulary for the user 120.

FIG. 2 is a block diagram of an exemplary implementation of a navigation system 200 in accordance with the present invention. As shown in FIG. 2, the navigation system 200 includes a positioning device 205 that initially determines the position of the user 120. Thereafter, positioning software 210 monitors the position of the user 120 for changes. If the user 120 has changed position by some distance, delta, from the last time the vocabulary was created, a vocabulary generator 240 generates a new vocabulary using the limiting process 400, discussed below in conjunction with FIG. 4, on the location database 100. The vocabulary generator 240 then replaces the current recognition vocabulary in the speech recognizor 230 with the newly created vocabulary.

The navigation system 200 also includes navigation software 220 that can be invoked by the positioning software 210 to monitor the position of the user 120 and notify the user 120 of the current position and provide direction changes to follow the calculated path to the requested destination, in a known manner. The navigation software 220 references the location database 100 to convert the current position of the user 120 to meaningful terms for the user and to plot paths to requested destinations. The navigation software 220 communicates the current position and changes in direction to the user 120 using an output interface 250. The form of the output may be, e.g., text to speech, graphical, or a tactile map.

The speech recognizor 230 is the input interface for the user 120. The speech recognizor 230 translates audio utterances from the user 120 to commands based upon the current vocabulary, in accordance with the present invention. The speech recognizor 230 then transfers these recognized commands to the navigation software 220 to be executed, in a conventional manner.

FIG. 3 contains a representation of the location database 100 containing entry names 310 corresponding to street names and local landmarks (not shown). The speech vocabulary 300 is generated by the limiting process 400, discussed below in conjunction with FIG. 4 and is composed of the list of database entry names culled from the entry names 310 using the distance limit 110. In addition, similar sounding names such as Grand and Grant are eliminated from the vocabulary since the distance between them prevents them from being in the same speech recognition vocabulary.

FIG. 4 is a flow chart describing an exemplary implementation of the limiting process 400. Initially, a new empty vocabulary is created during step 405 to begin the vocabulary building process. A pointer is then set to the first entry in the location database 100 during step 410. The difference, DIFF, between the current user position and the nearest point of the current entry is calculated during step 420.

A test is performed during step 430 to determine if the difference is within range 430 of the user 120. If it is determined during step 430 that the difference is within range 430 of the user 120, the name of the entry is added to the new vocabulary during step 440.

A further test is performed during step 450 to determine if the current entry being evaluated is at the end of the database. If the pointer is not the end of the entries, the pointer is advanced to the next entry during step 460, and program control returns to step 420 where the distance to this next entry is calculated.

If it is determined during step 450 that the pointer has reached the end of the location database 100, then the current speech recognizor 230 vocabulary is replaced by the newly created vocabulary during step 470. The culling process 400 then waits during step 480 to be invoked by the positioning software 210 when the user 120 has moved a sufficient distance from the current position. The culling process 400 then once again begins creation of a new vocabulary during step 405 to limit the names to the immediate area of the user 120.

In this manner, a navigational vocabulary is generated in accordance with the present invention containing only those entries that are most likely to be utilized, based on the current location and expected range of the user.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the worldwide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The memories employed by the present invention will configure one or more processors to implement the methods, steps, and functions disclosed herein. The memory could be distributed or local and the processor could be distributed or singular. The memory could be implemented as an electrical, magnetic or optical memory, or any combination of these or other types of storage devices. The term “memory” should be construed broadly enough to encompass any information able to be read from or written to an address in the addressable space accessed by a processor. With this definition, information on a network is still within a memory of the navigation system because the processor can retrieve the information from the network.

It is to be understood that the embodiments and variations shown and described herein are merely illustrative of the principles of this invention and that various modifications may be implemented by those skilled in the art without departing from the scope and spirit of the invention.

What is claimed is:

1. A method for generating a vocabulary for use by a speech recognition system, comprising:
determining a current location of a user within a geographic domain; and
generating a vocabulary of entries corresponding to geographic references within said geographic domain that are within a given distance of said user.

2. The method of claim 1, wherein said geographic references include street names within said geographic domain.

3. The method of claim 1, wherein said geographic references include landmarks within said geographic domain.

4. The method of claim 1, wherein said geographic references include points of interest within said geographic domain.

5. The method of claim 1, wherein said predefined distance is varied in proportion to an expected range of said user.

6. The method of claim 1, wherein said user is moving and said current location is an instantaneous position of said user.

7. The method of claim 1, wherein said geographic domain is selected from the group consisting essentially of a part of a geographic region, a part of a town, a part of a city and a floor plan of a building.

8. A method for entering information into a navigation system, comprising:
determining a current location of a user within a geographic domain;
generating a navigational vocabulary of entries corresponding to geographic references within said geographic domain that are within a given distance of said user; and
transcribing speech from said user to commands for said navigation system using said vocabulary.

9. The method of claim 8, wherein said geographic references include street names within said geographic domain.

10. The method of claim 8, wherein said geographic references include landmarks within said geographic domain.

11. The method of claim 8, wherein said geographic references include points of interest within said geographic domain.

12. The method of claim 8, wherein said predefined distance is varied in proportion to an expected range of said user.

13. The method of claim 8, wherein said user is moving and said current location is an instantaneous position of said user.

14. A speech recognition interface, comprising:
a position location for determining a current location of a user within a geographic domain;
geographic database having geographic references within said geographic domain; and
a processor for generating a speech recognition vocabulary containing entries corresponding to said geographic references that are within a given distance of said user.

15. The speech recognition system of claim 14, wherein said geographic references include street names within said geographic domain.

16. The speech recognition system of claim 14, wherein said geographic references include landmarks within said geographic domain.

17. The speech recognition system of claim 14, wherein said geographic references include points of interest within said geographic domain.

18. The speech recognition system of claim 14, wherein said predefined distance is varied in proportion to an expected range of said user.

19. The speech recognition system of claim 14, wherein said user is moving and said current location is an instantaneous position of said user.

20. The speech recognition system of claim 14, further comprising a navigation system for providing directions based on said geographic database and said current position of said user.

21. The speech recognition system of claim 14, further comprising a navigation system for providing navigational information based on said geographic database and said current position of said user.

22. An article of manufacture for generating a vocabulary for use by a speech recognition system, comprising:
a computer readable medium having computer readable code means embodied thereon, said computer readable program code means comprising:
a step to determine a current location of a user within a geographic domain; and
a step to generate a vocabulary of entries corresponding to geographic references within said geographic domain that are within a given distance of said user.
